(19) United States
(12) Patent Application Publication
(10) Pub. No.: US 2008/0170979 A1
(43) Pub. Date: Jul. 17, 2008

(54) Method for Making Alkali Resistant Ultra Pure Colloidal Silica

(75) Inventors: Yuhu Wang, Suzhou (CN); Ning Zhang, Suzhou (CN)

Correspondence Address: EDWARD S. SHERMAN, ESQ., 3554 ROUND BARN BLVD., SUITE 303, SANTA ROSA, CA, 95403, US

(73) Assignee: Suzhou Nanodispersions LTD, Jiangsu (CN)

(21) Appl. No.: 11/965,342

(22) Filed: Dec. 27, 2007

(30) Foreign Application Priority Data
Jan. 15, 2007 (CN) 200710019366.3

(51) Int. Cl. C01B 33/14

(52) U.S. Cl. 423/335

(57) ABSTRACT

This patent disclose a method for making ultra pure colloidal silica having metal impurities except potassium of less than about 1 ppm, at a pH of greater than about 6, with an average particle size of less than about 200 nm. Hydrolyzable silanes that can be purified by distillation, or their oligomers, are used as raw materials which are first dissolved in water with organic or inorganic acids. This acidic solution is slowly mixed with a basic solution with or without silicate at a temperature range 50-105° C. to form colloidal silica. The colloidal silica can be further concentrated to higher concentrations, greater than about 20% by evaporation or by ultrafiltration, or a combination thereof.

### CROSS REFERENCE TO RELATED APPLICATIONS

The present application claims priority to the Chinese Patent Application for “A Method for Making Alkali Resistant Ultra Pure Colloidal Silica” having application number: 200710019366.3 that was filed Jan. 15, 2007, which is incorporated herein by reference

### BACKGROUND OF INVENTION

The present invention relates a method of manufacturing colloidal silica, and in particular ultrapure colloidal silica.

Colloidal silica is a dispersion in which silicon dioxide particles are evenly suspended in water. While it finds many applications, ultra pure colloidal silica is mainly used in fine polishing of semiconductor substrates such as silicon or germanium wafers etc, or in the chemical mechanical planarization (CMP) process which is a key step in fabricating the multilayered structure in integrated chips, as well as in the fine polishing of Al based disks used in hard drive. Colloidal silica is one of the most important components in semiconductor polishing slurries, and an indispensable consumable in microelectronics industry. Ultra pure colloidal silica is the highest grade among the colloidal silica family. The most important feature of it is the very low level of metal impurities (below 10 parts per million (ppm) and even below 1 ppm), which is significantly lower than regular colloidal silica (with as much as 0.1% impurities, most of them being sodium ions that are harmful to many semiconductor devices). The significantly low metal impurities allow silicon wafers or the integrated circuit (IC) devices based on silicon to avoid contamination or possible damages during the polishing process. In addition, in the fine polishing slurries for semiconductor, many chemical additives necessarily co-exist with colloidal silica for desired performance. As the slurries are stored for long time, these chemical additives can react with the metal impurities to change the polishing slurry property, thus desired polishing will not be achieved. Ultra pure colloidal silica can reduce the possibilities of such chemical reaction, and greatly enhance the stabilities and the shelf life of polishing slurry. As the feature size of Cu lines in IC devices becomes narrower and more fragile, in part due the combination with low K dielectric materials which are becoming more commonly used in IC chips, it is desired to utilizes colloidal silica with better controlled impurities and particle size distributions for CMP.

However, the existing pure colloidal silica used in semiconductor polishing slurry has disadvantages. High purity colloidal silica can be divided into two classes according to the method of production. The first group or class is currently the dominant technology and uses water glass, which is a 40-50% aqueous solution of sodium silicate, as the raw material. which is the Normally, a basic water glass is first diluted and converted into metastable silicic acid (pH<2) using hydrogen (H⁻) type ion exchange resin. Then the silicic acid is slowly mixed with alkali solutions or with diluted basic silicate solution at an elevated temperature to form colloidal silica, via nucleation and particle growth. Alternatively, small sized colloidal silica can also be made by directly reacting basic a silicate solution with (H⁺) type cation exchange resin at an elevated temperature. The biggest drawback of these methods is that the final colloidal silica always contains certain level of metal impurities that can not be completely removed by ion exchange. These impurities mainly come from natural quartz sands and the impure soda hydroxide or soda carbonates used to fuse or to dissolve the sands. In addition, in the fusion process to make water glass, certain impurities can be introduced from the refractory materials in fusion tank or melting containers. Though by using ion exchange, majority of the impurities in water glass or others can be removed, it is very difficult to reduce the impurity level below 10 ppm. The impurity level largely depends upon the extent of ion-exchange. Some impurities, such as Al, B, Zr etc with high valence are incorporated in the framework of silicon dioxide molecular structure, so they can not be completely removed via normal ion exchange. These impurities in the structure framework of colloidal silica can be gradually leached out under a harsh chemical environment in slurries and react with the co-existing chemicals. The reaction can eventually lead to the precipitation or agglomeration of particles which can contaminate or damage the semiconductor to be polished. Therefore, the colloidal silica produced from water glass is mainly used in the polishing slurries that are used in the first or early step rough polishing. The resulting contaminated layers or surface need to be removed and recovered by following step of fine polishing and cleaning.

The colloidal silica from the water glass process can be concentrated to a concentration >40 wt % and shows good alkali resistance. But in fine polishing, especially in the final polishing step of bare semiconductor substrate or in CMP on the multi-layers in ICs, colloidal silica of higher purities with little trace metals is required. Colloidal silica with the requisite higher purity is difficult to make from water glass.

In addition, in making colloidal silica using water glass with ion exchange technology, large volume of bases, acids and pure water are used to wash the ion-exchange resin for regeneration, otherwise the ion exchange resin will quickly turn into hard solid with residual silicic acid and no longer function. This re-generation process releases large volume of waste solutions which need to be recycled. Thus the process, unless well controlled, is detrimental to the environment.

The other way of making ultra pure colloidal silica is to use hydrolysable silanes, such as tetraethoxysilane (TEOS), tetramethoxysilane (TMOS) as the raw materials in the Stober process. The silane is hydrolyzed in water alcohol mixture at the temperature (<50° C.) under the catalysis of ammonia, followed by condensation to form colloidal silica or the dispersions of silicon dioxide particles. As silane is normally immiscible with water, large quantity of alcohols such as methanol or ethanol need to be added to make silane and water miscible so that the hydrolysis reaction can proceed uniformly at a reasonable rate. After the hydrolysis and condensation reactions where silane is completely converted into colloidal silica, the solution is then heated up to an elevated temperature to assure no silane is left unreacted and to remove the catalyst ammonia and evaporate the large amount of methanol or ethanol as well as some of the water. As those raw materials such as TMOS, TEOS and those solvents, such as methanol, ethanol can be easily purified to electronic grade via distillation or ion-exchange, the final colloidal silica made from Stober process is ultra pure, where the metal impurities can be controlled below 1 ppm, far below the water glass process. The final pH of the colloidal silica made with this method can be close to neutral and the concentration is around 20%. Because of the ultra-purity, this type of colloidal silica has been increasingly used in the final polishing for semiconductor wafers, and CMP process in IC multiple layers fabrication. However, Stober process has the following draw backs:

Many semiconductors such as Si wafer or interlayer dielectric materials require polishing to be conducted under basic condition to achieve the desired performance. Under the basic condition, however, the Stober process derived colloidal silica normally provides lower polishing rate than the water-glass derived counterpart on many substances. One of the major reasons is that the Stober colloids have a poor alkali resistance, that is, under high pH (>9.5), the Stober colloidal silica are gradually dissolved in alkali solutions while the water-glass colloidal silica stays with little changes. Hence, it is difficult to use Stober colloidal silica at pH>9.5

As the raw materials, not only the electronic grade silanes, but also the electronic grade ammonia, methanol and ethanol are all expensive, the production cost is much higher with Stober process.

Without additives, the Stober colloidal silica normally has the concentration of 10-20%, especially when the particle size become small (<20 nm), far lower than the water glass colloidal silica which can be concentrated to >40%. Higher concentration of Stober colloidal silica turns easily to gel.

The above mentioned drawbacks are probably associated with the fact that Stober process is performed at low temperature, normally <50° C., and the particles are porous with lower density. The porous structure of Stober colloidal silica particles has been demonstrated from specific surface area measurement and also transmission electron microscopy (TEM) observations.

It is therefore a first object of the present invention to provide a method to synthesize colloidal silica that does not suffer the aforementioned disadvantages of the prior art, and in particular colloidal silica that is ultrapure.

It is another objective of the present invention to produce such ultrapure colloidal silica that is also stable in strong base/alkali solution.

It is a further objective of the present invention to produce such ultrapure colloidal silica in an inexpensive process relative to alternative methods.

### SUMMARY OF INVENTION

In the present invention, the first object is achieved by the method comprising: dissolving in an aqueous solution at least one of a silanes that can be purified via distillation or an oligomers thereof with at least one of an inorganic and organic acids to make a first solution of silicic acid; providing a second basic solution, and reacting the first solution of silicic acid with the second basic solution to synthesize colloidal silica.

Another aspect of the invention is achieved in the above process wherein second basic solution is made by dissolving in an aqueous solution at least one silanes that can be purified via distillation, or an oligomer thereof, with at least one of an organic and an inorganic bases to make a solution containing a silicate.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a block diagram of the process.

### DETAILED DESCRIPTION

The objective of this invention is to provide a method for making ultra pure colloidal silica which has purity as high as the Stober method colloids, that is, all the metal impurities are below 1 ppm, or all metal impurities except potassium (K) are below 1 ppm. At meantime, it has the alkali resistance close to or as well as the water glass derived colloidal silica. Potassium is viewed to be harmless or to have little negative effect upon most semiconductor polishing. The colloidal silica according to this invention has lower production cost than the Stober colloidal silica and yet can be concentrated to a high solid concentration that is above about 40 weight percent (wt %).

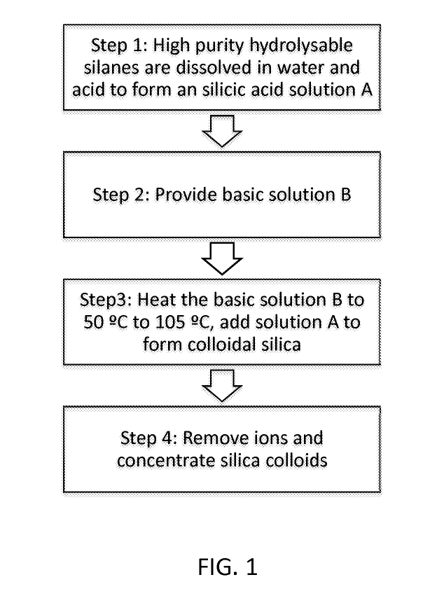

The technical approach of this invention for a method for making alkali resistant ultra pure colloidal silica includes the following steps, as illustrated in the block diagram of FIG. 1:

Step 1: High purity hydrolysable silanes such as TMOS or TEOS that have been distilled or the oligomers of silanes, for example, TEOS 40 are used as the raw materials. Directly the raw materials are dissolved in high purity aqueous acid solution to prepare a colorless transparent silicic acid solution. In order to accelerate the rate, heating might be provided. The acids can be high purity inorganic acids such as sulfuric acid, hydrochloric acid, nitric acid, hydrofluoric acid etc. or organic acids such as carboxylic acid including acetic acid, oxalic acid etc., as long as they help silanes dissolve in water completely and convert into silicic acid.

Step 2: Basic solution which can be aqueous solution of potassium hydroxide, potassium carbonate or organic potassium alkoxides such as potassium ethoxide or methoxide or the aqueous solution of ammonium hydroxide or amines including tetramethyl ammonium hydroxide (TMAH) etc are prepared separately. Alternatively, the basic solution can also be a colorless transparent solution containing silicate by dissolving silanes like TMOS, or TEOS or their oligomer in high purity alkali solution. The base is primarily potassium based, which can be inorganic potassium compounds like potassium hydroxide, potassium carbonate, or organic potassium alkoxides, such as potassium methoxide, or ethoxide etc., as long as silane can completely dissolved and converted to silicate. In addition, ammonium hydroxide and organic bases including amines such as TMAH can be used to dissolve silane to prepare a colorless transparent silicate solution.

Step 3, At the temperature between 50° C. to 105° C., the prepared transparent silicic acid solution and the basic solution with or without silicate are added together to allow colloidal silica to form via the nucleation and particle growth process.

Step 4, After the reaction, the solution is heated to distill out alcohol by-products including methanol or ethanol as well as certain amount of water, so that alkali resistant colloidal silica with solid concentration of at least about 20 wt %, pH of at least about 6, average particle size less than about 200 nm, all metal impurities less than 1 ppm or all metal impurities except potassium less than 1 ppm is made. In the process of evaporation for higher concentration, water or basic water solutions can be added to the colloidal silica to replace the by-product ethanol or methanol until all alcohol is removed.

The chemical reactions to form solution A and Solution B are provided below:

Si(OR)₄+H₂O→(in excess acid) Si(OH)₄+ROH (Solution A)

Solution B can be prepared by either of the following two alternatives:

Si(OR)₄+H₂O+MOH (in excess)→M-SiO₂+H₂O (Solution B), or

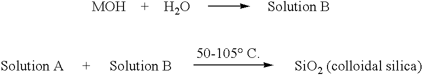

In the above equations R is preferably an alkyl group, including methyl and ethyl in TMOS and TEOS; M is cation, but preferably potassium (K) or ammonium (NH₄) cations; and preferably the acid used in excess include inorganic and organic acids such as sulfuric, nitric, hydrochloric acids), and the like; and preferably bases include organic and inorganic bases such as potassium hydroxide, carbonate, alkoxide, ammonium hydroxide and amines and the like.

In an alternative embodiment of the invention, colloidal silica can be also concentrated using ultra-filtration to achieve a concentration of at least about 20 wt % and to remove by-product alcohol.

In a preferred embodiment of the invention, in contrast to the Stober process, does not requires large amount of methanol or ethanol as solvent. Unlike traditional water glass process where water glass is converted into silicic acid via extensive ion exchange prior to the particle formation, the disclosed process does not requires large amount of ion exchange resin to be used, thus the production is environmentally friendly and the cost is greatly reduced.

The colloidal silica according to this invention has pH of at least about 6, silicon dioxide solid of at least about 20%, all metal impurities or all metal impurities except potassium less than 1 ppm, and the average particle size of about 200 nm or less.

In order to reduce the residual acid anions or potassium or ammonium cations, the final colloidal silica can be passed through an ion exchange column to exchange the acid anions with OH⁻ ions, and to exchange the potassium or ammonium cations with H⁺ ions.

Although this invention uses the similar raw materials as the Stober process, the reaction conditions, manufacturing cost as well as the mechanism are different. In Stober process, colloidal silica is directly synthesized in basic water-solvent solution via the hydrolysis and condensation of silane under the catalysis of ammonium hydroxide at low temperature of less than about 50° C. In this invention, silane is first dissolved in acid solution to convert into silicic acid solution; hereafter the colloidal silica is synthesized from the reaction between the silicic acid solution and aqueous basic solution with or without silicate at the temperature region 50-100° C. In addition, the particle size, the size distribution of the colloidal silica from this invention can be controlled via the controlling of temperature of reaction, the concentration of the solution and the adding rate of the reactants. Use of seeds, i.e., small size of colloidal silica in reaction can also help produce large size particles.

The most significant advantages of this invention are:

The colloidal silica from this invention is as pure as the Stober process colloidal silica, that is, the impurities of all metals or all metals except potassium are less than 1 ppm. In most cases, potassium has no negative effect upon the polishing of semiconductor.

The alkali resistance of the colloidal silica from this invention is as good as that of water glass derived colloidal, which is much better than Stober colloidal silica. Therefore, under basic condition, the colloidal silica of this invention should polish SiO₂, silicon, germanium wafers etc at a rate higher than Stober colloidal silica.

Similar to water glass based colloidal silica, the colloidal silica from this invention can be concentrated into high concentration (at least about 40 wt %).

The process of this invention does not use alcohols such ethanol or methanol as solvent, nor ion-exchange resins to convert silicate into silicic acid. Therefore no large quantity of waste solution is released, and the production cost is greatly reduced compared with Stober process.

Following examples are provided to further explain this invention.

### EXAMPLE 1

40 g of TMOS are dissolved in 400 g of sulfuric acid solution (0.1%), which is stirred until the solution become colorless and transparent (solution A). Separately, 20 g of TMOS purified via distillation are dissolved in 100 g of KOH water solution (1.4%), which is heated up while stirring until the solution becomes transparent (solution B).

Solution B is heated up to boiling, and solution A is added to Solution B at a constant rate over 40 minutes. After the addition, the solution is kept stirring for additional 15 minutes to evaporate the by-product methanol and some water. A colloidal silica that has a concentration of >20 wt %, pH=9.5 is thus produced. The average particle size via dynamic light scattering measurement is 70 nm. The specific surface area by BET method is measured as 54 m²/g.

After treated using HF—HNO₃, the metal impurities of the colloidal silica are measured using ICP-mass. The results are as follows:

Al, Ca, Fe, Mg, Na and Zn: less than 100 parts per billion (ppb)

K: 5750 parts per million (ppm)

Other metals were not detectable. The above results demonstrate that the metal impurities except potassium are very low. Though at a high level, K has no negative effect upon semiconductor polishing.

### EXAMPLE 2

200 g of TMOS is dissolved in 500 g of 0.2% sulfuric acid, and is stirred till a colorless and transparent solution (solution A) is formed. Separately, 200 g of 2.2 wt % potassium hydroxide (KOH) solution with water is prepared in a container (solution B). Solution B is heated to boiling to which solution A is added at a constant rate over 100 minutes. After addition, the solution is kept stirring for 15 minutes to remove the by-product methanol and certain amount of water via evaporation. The colloidal silica thus prepared has concentration >20 wt %, pH 9.5. The average particle size via dynamic light scattering is 72 nm. This colloidal silica shows specific surface area by BET method 51 m²/g. The following metal impurities were measured using ICP-MS on a sample pretreated with HNO₃/HF.

Al, Ca, Fe, Mg, Na, Zn: less than 100 ppb

K: 8840 ppm

Other metal impurities were not detectable. The above results demonstrate that this colloidal has very low impurities except K which normally has no negative effect upon semiconductor polishing.

### EXAMPLE 3

80 g of TMOS is dissolved in 400 g of water with 0.1% sulfuric acid (Solution A). Separately, 20 g of 28% ammonium hydroxide is diluted with 100 g of water (Solution B). Solution B is heated to temperature 80° C. to which Solution A is added over 40 minutes. Stirring is kept for 15 minutes after the addition to remove the by-product methanol and certain amount of water, and in order to keep the pH, diluted ammonium hydroxide at 0.28% is added. The colloidal silica has >20 wt %, pH=9. From dynamic light scattering measurement, the average particle size is 65 nm. Using ICP-MS, following results are obtained.

Al, Ca, Fe, K, Mg, Na and Zn: less than 100 ppb

Other metals were not detectable.

### COMPARISON EXAMPLE 1

Colloidal silica is synthesized via Stober process as follows: 180 g of TMOS that has been purified via distillation is mixed with 140 g of methanol in a container (solution A); Separately in another container, 390 g of methanol, 140 g of water and 20 g of ammonium hydroxide (28 wt %) were mixed together (solution B). Solution A is drop wise added to solution B, followed by heating up the solution to 100° C. to remove ammonia and methanol via evaporation. The final colloidal silica is 20 wt %, and pH=7.0. From dynamic light scattering measurement, the average particle size is 71 nm and from BET, the specific surface area is 102 m²/g. The colloidal silica is treated using HF—HNO₃ and the metal impurities were measured using ICP-MS as follows:

Al, Ca, Fe, K, Mg, Na, and Zn: less than 100 ppb

The above average particle size and the surface area results demonstrate that the colloidal silica from comparison example 1 has a much higher surface area and hence a higher porosity than others. In other word, the Stober colloidal silica is less dense.

Alkali Resistance Test:

From the products of example 1, example 2 and comparison example 1, 10 g of each sample are taken respectively into glass bottles. 3 g of 45% KOH solution is added to each sample, while stirring. They were put into an oven of 60° C. Shortly, the colloidal silica from comparison example 1 is dissolved and turned to a colorless transparent solution, while the colloidal silica from example 1 and 2 are still milky white. This result confirms that the colloidal silica from this invention has better alkali resistance than Stober colloidal silica.

This invention has the following positive effects:

Alkali resistant ultra pure colloidal silica disclosed from this invention has pH>6, average particle size <200 nm, and all trace metals except K<1 ppm.

The above colloidal silica is made as follows: organic silanes that can be purified via distillation or their oligomer are used as the raw material and are first dissolved in water with inorganic or organic acids (Solution A). Separately they are also dissolved in water with organic or inorganic bases (Solution B). Silicic acid solution (Solution A) and basic silicate solution (Solution B) are reacted with each other at the temperature 50-105° C.

The above colloidal silica can also be made as follows: organic silane that can be purified via distillation or their oligomer are used as the raw material which is first dissolved in inorganic or organic acids (Solution A) and then added to alkali solutions that do not contain silicate (Solution B). Reaction is conducted in the temperature range of about 50° C.-100° C.

The above silanes that can be purified via distillation include TMOS, TEOS etc. The inorganic acids include sulfuric, hydrochloric, nitric, hydrofluoric acids etc., and the organic acids include carboxylic acids such as acetic, oxalic acids etc. Inorganic bases include potassium hydroxide, potassium carbonate, ammonium hydroxide etc. Organic bases include potassium methoxide, potassium ethoxide, amines such as TMAH.

The colloidal silica is heated to boiling to remove the by-product such as methanol or ethanol and part of water to concentrate it to a concentration of at least about 20 wt %.

The colloidal silica can be also concentrated by cycling through an ultrafiltration module to reduce the water and alcohol and reach the concentration of at least about 20 wt %. Such a process of ultrafiltration is disclosed in U.S. Pat. No. 6,747,065, which is incorporated herein by reference, and includes the removal of ions by flushing with excess water during ultrafiltration. Thus, the acid anions in the above colloidal silica can be reduced or removed by ion exchange using anionic exchange resin or by ultrafiltration. Further, the potassium and ammonium ions can also be reduced via ion exchange using cationic exchange resin or by ultrafiltration.

The following (Example 4) is a proposed hypothetical method for the synthesis of larger particles:

One should first provide 50 g of 2.2 wt % KOH solution in water in a container (solution B). Separately, 200 g of TMOS should be dissolved in 500 g of 0.1 wt % sulfuric acid, and then is stirred till a colorless and transparent solution is formed (solution A). Solution B should be heated to boiling to which solution A is added at a constant rate over 60 minutes. After addition, the solution is kept stirring for 15 minutes under reflux. The colloidal silica thus prepared is expected to shows an average size of about 30 to 40 nm and a concentration at about 8 to about 12 wt %, and will thus served as seeds in the next stage.

In the second stage 200 g of a 2.2 wt % KOH solution should be mixed with 20 g of the seeds, that is the colloidal silica of 40 nm at 10.6 wt % prepared above in a container (solution B). Separately, 200 g of TMOS should be dissolved in 500 g of 0.2 wt % sulfuric acid, and then stirred till a colorless and transparent solution (solution A) is formed. Solution B should be heated to boiling to which solution A is added at a constant rate over 150 minutes. After this step of addition, the solution is kept stirring for 15 minutes to remove the by-product methanol and certain amount of water via evaporation. The colloidal silica thus prepared can be further passed through an ultrafiltration module to reach a final colloidal silica of concentration 30 wt %, pH 9.5. The average particle size via dynamic light scattering is expected to be about 105-115 nm and a surface area of about 25 to 350 m²/g.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A method for making alkali resistant ultrapure colloidal silica, the method comprising:
a. dissolving in an aqueous solution at least one of a silanes that can be purified via distillation or an oligomers thereof with at least one of an inorganic and organic acids to make a first solution of silicic acid;
b. providing a second basic solution,
c. reacting the first solution of silicic acid with the second basic solution to synthesize colloidal silica.

2. A method of making alkali resistant ultrapure colloidal silica according to claim 1 wherein said second basic solution is made by dissolving in an aqueous solution at least one silanes that can be purified via distillation, or an oligomer thereof, with at least one of an organic and an inorganic bases to make a solution containing a silicate.

3. A method of making alkali resistant ultrapure colloidal silica according to claim 1 wherein said step of reacting is carried out below a temperature of about 105° C.

4. A method of making alkali resistant ultrapure colloidal silica according to claim 1 wherein said step of reacting is carried out at a temperature between about 50 and 105° C.

5. A method of making alkali resistant ultrapure colloidal silica according to claim 1 further comprising the step of heating the colloidal silica as synthesized to the boiling point at a pressure no greater than ambient pressure to remove at least one of the by-products of the reaction until the final concentration of the colloidal silica becomes at least as high as about 20 wt %.

6. A method of making alkali resistant ultrapure colloidal silica according to claim 1 further comprising ultrafiltration to remove part of the water and alcohol by-products until the final concentration of the colloidal silica becomes at least as high as about 20 wt %.

7. A method of making alkali resistant ultrapure colloidal silica according to claim 1, wherein the at least on silanes is selected from the group consisting of tetramethoxy silane (TMOS) and tetraethoxy silane (TEOS) and oligomers thereof.

8. A method of making alkali resistant ultrapure colloidal silica according to claim 1, wherein the at least one silane oligomer is TEOS-40.

9. A method of making alkali resistant ultrapure colloidal silica according to claim 1, wherein the first solution of silicic acid comprises an inorganic acids that is selected from the group consisting of sulfuric, hydrochloric, nitric and hydrofluoric acid.

10. A method of making alkali resistant ultrapure colloidal silica according to claim 1, wherein the first solution of silicic acid comprises an organic acids that is selected from the group consisting of carboxylic acids, acetic acid and oxalic acids.

11. A method of making alkali resistant ultrapure colloidal silica according to claim 1, wherein the second solution comprises an inorganic bases that is selected from the group consisting of potassium hydroxide or potassium carbonate or potassium hydrogen carbonate, or ammonium hydroxide.

12. A method of making alkali resistant ultrapure colloidal silica according to claim 1, wherein the second solution comprises an organic bases that is selected from the group consisting of potassium methoxide or potassium ethoxide.

13. A method of making alkali resistant ultrapure colloidal silica according to claim 1, wherein the second solution comprises an organic base that is selected from the group consisting of amines that includes tetramethyl ammonium hydroxide (TMAH).

14. A method of making alkali resistant ultrapure colloidal silica according to claim 1, further comprising the step of removing the residual acid anions in the colloidal silica by a process selected from the group consisting of ion exchanges using anion type ion exchange resin and ultrafiltration.

15. A method of making alkali resistant ultrapure colloidal silica according to claim 1, further comprising the step of removing potassium or ammonium ions by a process selected from the group consisting of ion exchange using cation type ion exchange resins and via ultrafiltration.

16. A method of making alkali resistant ultrapure colloidal silica according to claim 14, further comprising the step of removing potassium or ammonium ions by a process selected from the group consisting of ion exchange using cation type ion exchange resins and via ultrafiltration.

17. A method of making alkali resistant ultrapure colloidal silica according to claim 2 wherein said step of reacting is carried out below a temperature of about 105° C.

18. A method of making alkali resistant ultrapure colloidal silica according to claim 2 wherein said step of reacting is carried out at a temperature between about 50 and 105° C.

19. A method of making alkali resistant ultrapure colloidal silica according to claim 2 further comprising the step of heating the colloidal silica as synthesized to the boiling point at a pressure no greater than ambient pressure to remove at least one of the by-products of the reaction until the final concentration of the colloidal silica becomes at least as high as about 20 wt %.

20. A method of making alkali resistant ultrapure colloidal silica according to claim 2 further comprising the step of ultrafiltering the colloidal silica as synthesized until the final concentration of the colloidal silica becomes at least as high as about 20 wt %.
